(19) United States
(12) Patent Application Publication
(10) Pub. No.: US 2018/0088979 A1
(43) Pub. Date: Mar. 29, 2018

(54) VIRTUAL MACHINE LIVELINESS DETECTION

(71) Applicants: ATI Technologies ULC, Markham (CA); Advanced Micro Devices (Shanghai) Co. Ltd., Shanghai (CN)

(72) Inventors: YINAN JIANG, MARKHAM (CA); LingFei Liu, Shanghai (CN)

(21) Appl. No.: 15/348,175

(22) Filed: Nov. 10, 2016

(30) Foreign Application Priority Data
Sep. 23, 2016 (CN) 201610848543.8

(51) Int. Cl. G06F 9/455; G06F 11/34; G06F 11/30

(52) U.S. Cl. CPC G06F 9/45558; G06F 9/4406; G06F 11/3024; G06F 11/3433

(57) ABSTRACT

A time stamp value associated with a virtual function of a guest virtual machine (VM) is periodically updated. One of a plurality of idle worker threads in a thread pool is assigned to periodically increment the time stamp value after initialization of an instance of the guest VM. An inactive status of the guest VM is detected based at least in part on the time stamp value not changing over a specified time period. The provision of resources to the virtual function of the inactive guest VM can be terminated based on its inactive status. In one embodiment, the virtual function is associated with a graphics processing unit (GPU) and terminating the provision of resources includes terminating the scheduling of cycles of GPU time.

### BACKGROUND

### Description of the Related Art

Virtualization of computer resources allows the sharing of physical resources of a host system between different virtual machines (VMs), which are software abstractions of physical computing resources. The host system allocates a certain amount of its physical resources to each of the VMs so that each VM is able to use the allocated resources to execute applications, including operating systems (referred to as “guest operating systems”). Virtualization technology enables system administrators to shift physical resources into a virtual domain. For example, the physical host system can include physical devices (such as a graphics card, a memory storage device, or a network interface device) that, when virtualized, include a corresponding virtual function (VF) for each VM executing on the host system. As such, the VFs provide a conduit for sending and receiving data between the physical device and the virtual machines.

VMs and their corresponding VFs can sometimes encounter unexpected crashes or otherwise become unresponsive. When VM crashes occur, resources that the VF was previously accessing become unavailable, which can cause the VF to hang. This malfunction of the VF can be resolved by resetting the VF, such as by issuing a Function Level Reset (FLR) command to the VF. However, the individual FLR command to the VF is sometimes not successful due to various errors, which may lead to a FLR command being applied to the entire physical device, causing a reset of all other VMs and VFs and impacting overall efficiency of the host system.

### BRIEF DESCRIPTION OF THE DRAWINGS

FIG. 1 is a block diagram of a system for hosting virtual machines in accordance with some embodiments.

FIG. 2 is a block diagram illustrating an embodiment of a host system in accordance with some embodiments.

FIG. 3 is a diagram illustrating the detection of inactive VMs in accordance with some embodiments.

FIG. 4 is a flow diagram illustrating an example method for the detection of inactive virtual machines in accordance with some embodiments.

### DETAILED DESCRIPTION

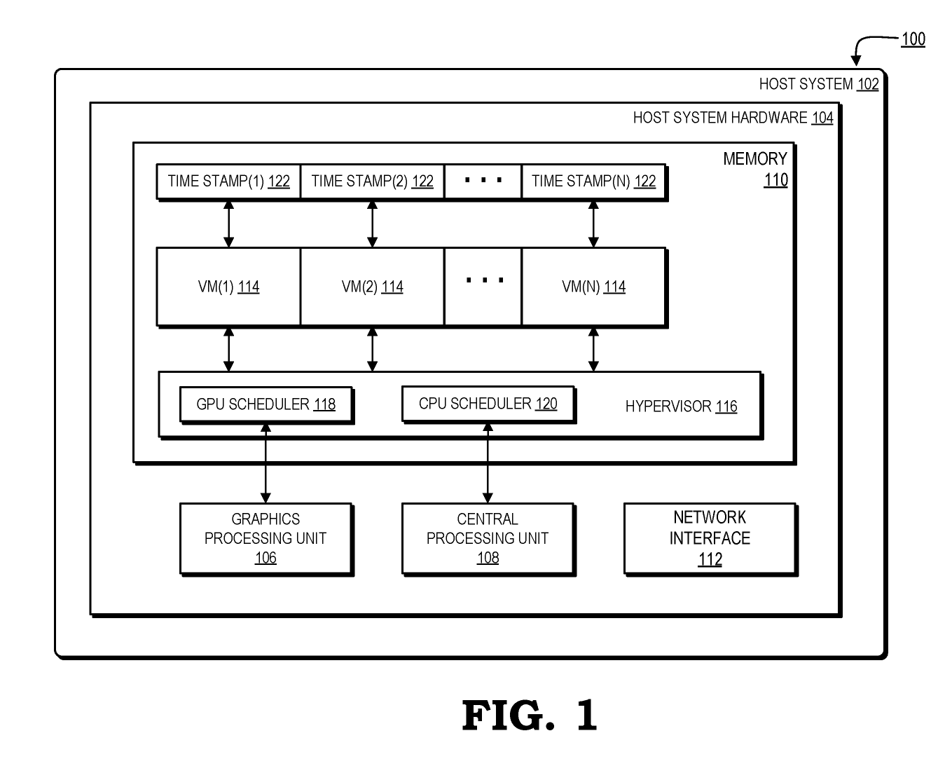

FIGS. 1-4 illustrate techniques for tracking the status of executing virtual machines (VMs) to identify crashes and to prevent virtual functions associated with crashed VMs from consuming physical resources of a host system. In some embodiments, a time stamp value associated with a virtual function of a guest virtual machine (VM) is periodically updated. One of a plurality of idle worker threads in a thread pool is assigned to periodically increment the time stamp value after initialization of an instance of the guest VM. An inactive status of the guest VM is detected based at least in part on the time stamp value not changing over a specified time period. The provision of resources to the virtual function of the inactive guest VM is terminated based on its inactive status. In one embodiment, the virtual function is associated with a graphics processing unit (GPU) and terminating the provision of resources includes terminating the scheduling of cycles of GPU time. Further, any virtual functions associated with the inactive guest VM is moved to an inactive list. Preventing virtual functions in the inactive list from communicating with inactive guest VMs helps to avoid stalls or hangs in the virtual functions.

FIG. 1 is a block diagram of a processing system 100 for hosting virtual machines in accordance with some embodiments. The system 100 comprises a host system 102 having host system hardware 104 that includes a graphics processing unit (GPU) 106 (e.g., a graphics card or graphics processor), a central processing unit (CPU) 108, a memory 110, and a network interface controller 112. The GPU 106 is a graphics rendering device for rendering a computer graphics frame for eventual display. The CPU 108 is a microprocessor or a microcontroller as generally known in the art, and generally facilitates input/output processing, application software, drivers, display creation and virtualization management. The memory 110 includes any permanent or volatile memory capable of storing instructions. The host system 102 is coupled to one or more remote clients (not shown) over a network via the network interface controller 112.

In the example processing system 100 of FIG. 1, multiple virtual machines (VMs) 114 are configured in memory 110 on the host system 102. Resources from physical devices of the host system 102 are shared with the VMs 114. The resources include, for example, a graphics processor resource from GPU 106, a central processing unit resource from CPU 108, a memory resource from memory 110, a network interface resource from network interface controller 112, or the like. The VMs 114 use the resources for performing operations on various data (e.g., video data, image data, textual data, audio data, display data, peripheral device data, etc.). In one embodiment, the host system 102 includes a plurality of resources, which are allocated and shared amongst the VMs 114.

The processing system 100 also includes a hypervisor 116 that is configured in memory 110. The hypervisor 116 is also known as a virtualization manager or virtual machine manager (VMM). The hypervisor 116 controls interactions between the VMs 114 and the various physical hardware devices of the host system 102 (i.e., resources), such as the GPU 106, the CPU 108, the memory 110, and/or the network interface 112. The hypervisor manages, allocates, and schedules resources that include, but are not limited to, CPU processing time or order, GPU processing time or order, memory, bandwidth usage, and memory usage. In one embodiment, the hypervisor 116 comprises a set of processor-executable instructions in the memory 110 for adjusting the provisioning of resources from the hardware devices to the VMs 114 using a GPU scheduler 118 and a CPU scheduler 120.

The GPU scheduler 118 manages and provisions GPU bandwidth of the GPU 106 by scheduling cycles of GPU time to the VMs 114. In one embodiment, the GPU scheduler 118 schedules cycles of GPU time to the VMs 114 in a round-robin fashion. Once scheduled, a particular VM will not be allocated additional cycles of GPU time until all other VMs have been scheduled. For example, according to a hypothetical round-robin scheduling, VM(1) 114 is provisioned four cycles of GPU time. After those four cycles of GPU time are consumed by graphics processing for VM(1) 114, no further cycles of GPU time are scheduled for VM(1) 114 until each of the other VMs (e.g., VM(2)-VM(N)) have consumed their provisioned four cycles of GPU time.

Similarly, the CPU scheduler 120 manages and provisions CPU bandwidth of the CPU 108 by scheduling cycles of CPU time to the VMs 114. In one embodiment, the CPU scheduler 120 schedules cycles of CPU time to the VMs 114 in a round-robin fashion. Once scheduled, a particular VM will not be allocated additional cycles of CPU time until all other VMs have been scheduled. For example, according to a hypothetical round-robin scheduling, VM(1) 114 is provisioned four cycles of CPU time. After those four cycles of CPU time are consumed by graphics processing for VM(1) 114, no further cycles of CPU time are scheduled for VM(1) 114 until each of the other VMs (e.g., VM(2)-VM(N)) have consumed their provisioned four cycles of CPU time.

The processing system 100 also includes one or more time stamps 122 (e.g., TIME STAMP(1)-TIME STAMP(N)) that are configured in memory 110. The time stamps 122 are counters, wherein each counter is associated with a different one of the VMs 114. For example, TIME STAMP(1) is associated with VM(1), TIME STAMP(2) is associated with VM(2), and so forth. Each time stamp 122 has a time stamp value that is periodically updated after initialization of an instance of its associated VM.

In one embodiment, the time stamp value of each of the one or more time stamps 122 is set at an initial value of zero upon initialization of their associated VMs 114. The time stamp value is periodically incremented by its associated VM in accordance with the number of cycles of GPU and/or CPU time consumed. The time stamp value thus provides a measure of computing resources consumed by each of the VMs 114. In another embodiment, the time stamp value of each of the one or more time stamps 122 is set at an initial value of zero upon initialization of their associated VMs 114, and the time stamp value is periodically incremented by its associated VM with every clock cycle of the CPU 108 on the host system 102. The time stamp thus provides a counter of the number of CPU cycles since initialization or reset of its associated VM. In other embodiments, the time stamp value of each of the one or more time stamps 122 is set at a value of zero upon initialization of their associated VMs 114; a time stamp value is periodically incremented by a predetermined amount by its associated VM. As long as the VMs 114 remain active and have not crashed or otherwise become unresponsive, time stamp values of the one or more time stamps 122 registered to their respective VMs 114 will continue to increment over time. An inactive status of a VM is detected based at least in part on the time stamp value not changing over a specified time period. A failure of any of the time stamps 122 to change over a predetermined period of time indicates that its respective VM 114 has become inactive (e.g., crashed or was killed off).

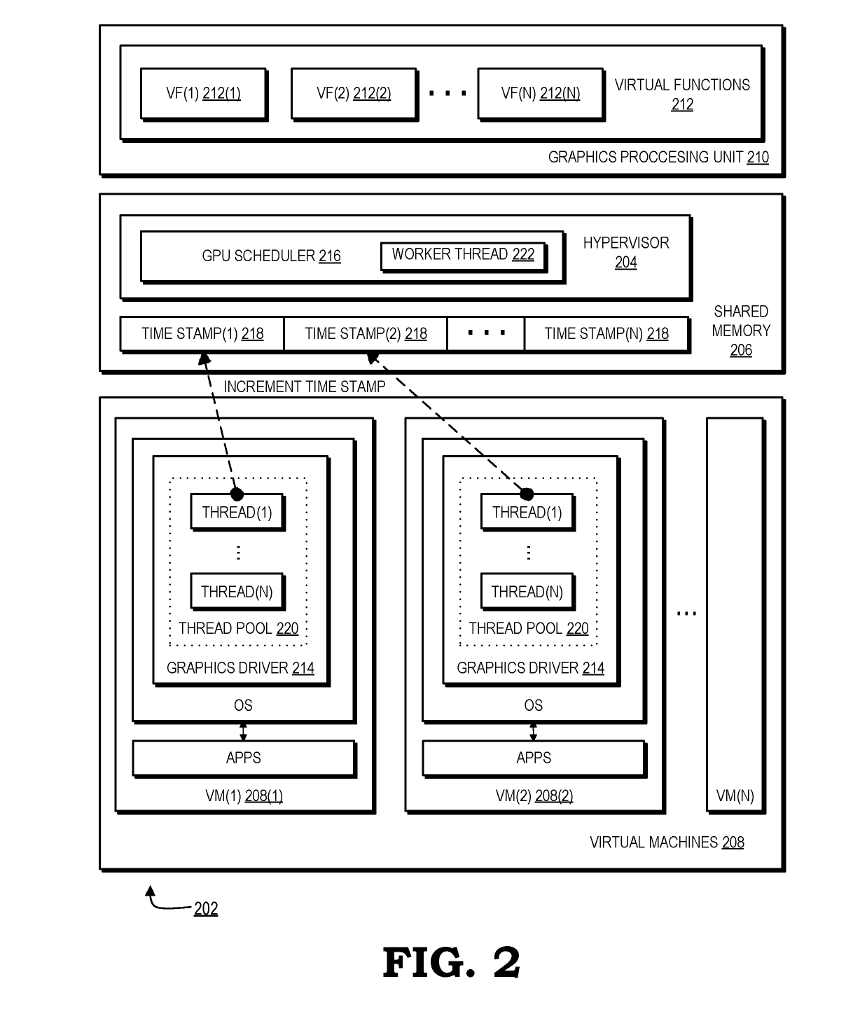

FIG. 2 is a block diagram illustrating an embodiment of a host system 202 that depicts the host system 102 of FIG. 1 in greater detail. As previously discussed, a hypervisor 204 is configured in shared memory 206 and runs on the host system 202 to initialize and manage instances of guest virtual machines (VMs) 208. In some embodiments, the host system 202 is a centralized server that is partitioned into multiple VMs to provide virtual desktops to users.

The hypervisor 204 includes software components for managing hardware resources and software components for virtualizing or emulating physical devices (e.g., hardware of the host system 202) to provide virtual devices, such as virtual disks, virtual processors, virtual network interfaces, or a virtual GPU as further described herein for each virtual machine 208. In one embodiment, each virtual machine 208 is an abstraction of a physical computer system and may include an operating system (OS), such as Microsoft Windows® and applications, which are referred to as the guest OS and guest applications, respectively, wherein the term “guest” indicates it is a software entity that resides within the VMs.

The VMs 208 are generally instanced, meaning that a separate instance is created for each of the VMs 208. Although two virtual machines (e.g., VM(1) 208(1) and VM(2) 208(2)) are shown, one of ordinary skill in the art will recognize that host system 202 can support any number of virtual machines. As illustrated, the hypervisor 204 provides two virtual machines 208(1) and 208(2), with each of the guest virtual machines 208 providing a virtual environment wherein guest system software resides and operates. The guest system software comprises application software (APPS) and device drivers, typically under the control of the guest OS. In some embodiments, the application software comprises a plurality of software packages for performing various tasks (e.g., word processing software, database software, messaging software, and the like).

In various virtualization environments, single-root input/output virtualization (SR-IOV) specifications allow for a single Peripheral Component Interconnect Express (PCIe) device to appear as multiple separate PCIe devices. A physical PCIe device of the host system 202 (such as graphics processing unit 210, shared memory 206, or a central processing unit) having SR-IOV capabilities is configured to appear as multiple functions. The term “function” as used herein refers to a device with access controlled by a PCIe bus. SR-IOV operates using the concepts of physical functions (PF) and virtual functions (VFs), where physical functions are full-featured functions associated with the PCIe device. Virtual functions, however, are derived from a physical function and represent functions that lack configuration resources and only process input/output. Generally, each of the VMs is assigned to a VF.

In the example embodiment of FIG. 2, SR-IOV specification enables the sharing of graphics processing unit 210 among the virtual machines 208. The graphics processing unit 210 is a PCIe device having a physical function (not shown). The virtual functions 212 are derived from the physical function of the graphics processing unit 210, thereby mapping a single physical device (e.g., the graphics processing unit 210) to a plurality of virtual functions 212 that is shared with guest virtual machines 208. In some embodiments, the hypervisor 204 maps (e.g., assigns) the virtual functions 212 to the guest virtual machines 208. For example, VF(1) 212(1) is mapped to VM(1) 208(1), VF(2) 212(2) is mapped to VM(2) 208(2), and so forth. The virtual functions 212 appear to the OS of their respective virtual machines 208 in the same manner as a physical GPU would appear to an operating system, and thus, the virtual machines 208 use the virtual functions 212 as though they were a hardware device.

Driver support for the virtual functions 212 is provided using virtual graphics drivers 214 installed in the guest OS of the virtual machines 208. As used herein, a device driver is a computer program based component that configures a machine and acts as a translator between a physical device and the applications or operating systems that use the device. A device driver typically accepts generic high-level commands and breaks them into a series of low-level, device-specific commands as required by the device being driven. The virtual graphics drivers 214 perform the same role as a typical device driver except that it configures the host system 202 to provide translation between the virtual functions 212 that provide hardware emulation and the guest OS/application software running on the VMs 208.

A GPU scheduler 216 is configured in the hypervisor 204 to manage the allocation of GPU resources to perform the operations of the virtual functions 212. In one embodiment, the GPU scheduler 216 manages and provisions GPU bandwidth of the GPU 210 by time-slicing between the VMs 208 according to a round-robin or some other predetermined priority-based scheduling scheme. For example, in one embodiment, the GPU scheduler 216 periodically switches allocation of GPU bandwidth between the VMs 208 based on an allocated time period for each VM (e.g., a predetermined number of GPU clock cycles). Once scheduled, a particular VM will not be allocated additional cycles of GPU time until all other VMs have been scheduled. For example, according a hypothetical round-robin scheduling, VM(1) 208(1) is provisioned four cycles of GPU time. After those four cycles of GPU time are consumed by graphics processing for VM(1) 208(1), no further cycles of GPU time are scheduled for VM(1) 208(1) until each of the other VMs (e.g., VM(2)-VM(N)) have consumed their provisioned four cycles of GPU time.

The host system 202 also comprises one or more time stamps 218 (e.g., TIME STAMP(1)-TIME STAMP(N)) that are configured in shared memory 206. The time stamps 218 are counters associated with the VMs 208. For example, TIME STAMP(1) is associated with VM(1), TIME STAMP(2) is associated with VM(2), and so forth. Each time stamp 218 has a time stamp value that is periodically updated after initialization of an instance of its associated VM. In one embodiment, the time stamp value of each of the one or more time stamps 218 is set at a value of zero upon initialization of their associated VMs 208; a time stamp value is periodically incremented by its associated VM by increasing the time stamp value in accordance with the number of cycles of GPU time consumed. Such a time stamp provides a measure of GPU resources consumed by each of the VMs 208. In another embodiment, the time stamp value of each of the one or more time stamps 218 is set at a value of zero upon initialization of their associated VMs 208; a time stamp value is periodically incremented by its associated VM by incrementing the time stamp value with every clock cycle of the GPU 210 on the host system 202. Such a time stamp provides a counter of the number of GPU cycles since initialization or reset of its associated VM. In other embodiments, the time stamp value of each of the one or more time stamps 218 is set at a value of zero upon initialization of their associated VMs 208; a time stamp value is periodically incremented by a predetermined amount by its associated VM.

Each of the VMs 208 maintains a thread pool 220 having a number of available worker threads to perform various tasks. Each worker thread (e.g., THREAD(1) through THREAD(N)) provides a thread of execution which may be assigned a task to perform. In operation, one of the worker threads of each VM 208 is registered to a time stamp 218 and is assigned to periodically increment the time stamp value of the time stamp 218 while its respective VM is active. For example, in the embodiment of FIG. 2, THREAD(1) in the thread pool 220 of VM(1) 208(1) is registered to TIME STAMP(1) 218. THREAD(1) in the thread pool 220 of VM(2) 208(2) is registered to TIME STAMP(2) 218. After the graphics driver 214 of a VM 208 finishes its initialization tasks, the THREAD(1) worker thread periodically increments the time stamp value of its registered time stamp 218, according to the various embodiments described above.

A worker thread 222 in the GPU scheduler 216 is tasked with monitoring the time stamps 218 determine whether the time stamp values keep changing within a predetermined period of time. As long as the VMs 208 remain active and have not crashed or otherwise become unresponsive, time stamp values of the time stamps 218 registered to their respective VMs 208 will continue to increment over time. A failure of any of the time stamps 218 to change over the predetermined period of time indicates that its respective VM 208 has become inactive (e.g., crashed or was killed off). Therefore, the virtual functions 212 for an inactive VM no longer needs GPU resources.

When VM crashes occur, resources that the VF was previously accessing on the VM become unavailable, which causes the VF to hang. In response to detecting the inactive status of a VM 208, the GPU scheduler 216 moves the inactive VM to an inactive list and terminate the scheduling of GPU bandwidth to the virtual function 212 of the inactive VM. Because GPU bandwidth is no longer scheduled for the virtual function 212 of the inactive VM, GPU activity will not occur on that virtual function 212; therefore, VF hangs is avoided by preventing virtual functions 212 from communicating with inactive VMs.

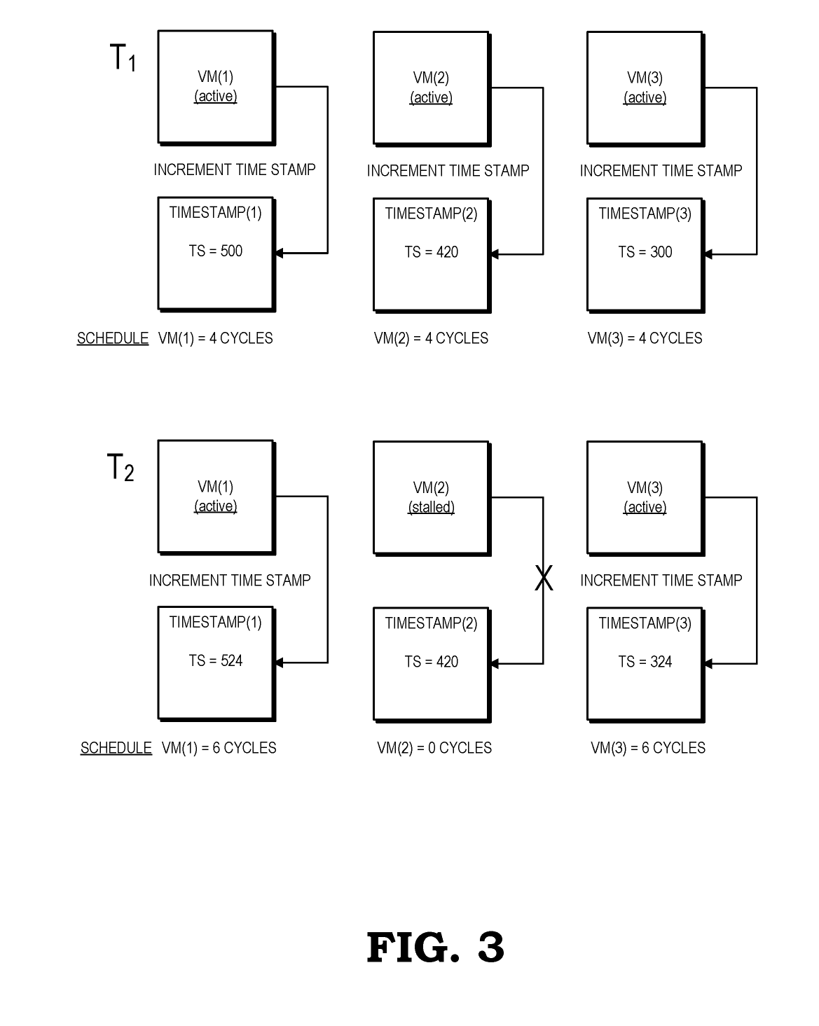

FIG. 3 is a diagram illustrating the detection of inactive VMs in accordance with some embodiments. As shown, time stamp values are monitored to determine the active status of three virtual machines (e.g., VM(1), VM(2), and VM(3)). At a first point in time T₁, all three of the virtual machines are active with VM(1), VM(2) and VM(3) having time stamp values in TIMESTAMP(1), TIMESTAMP(2), and TIMESTAMP(3) of TS=500, TS=420, and TS=300, respectively. Accordingly, each of the three virtual machines is scheduled four cycles of GPU time such that the VMs take turns using GPU resources in a round-robin scheduling scheme, as previously described.

At a second point in time T₂, the time stamp values in TIMESTAMP(1) and TIMESTAMP(3) have incremented to TS=524 and TS=324 for VM(1) and VM(3), respectively. Therefore, monitoring the time stamp values shows that VM(1) and VM(3) remain active at time T₂. However, at time T₂, the time stamp value in TIMESTAMP(2) for VM(2) has remained the same at TS=420 relative to its value of TS=420 for time T₁. The failure of the time stamp value of TIMESTAMP(2) to change from time T₁ to T₂ indicates that VM(2) has stalled (or otherwise become inactive). Therefore, the virtual function for inactive VM(2) no longer needs GPU resources. Accordingly, the provisioning of GPU resources to the virtual function of VM(2) is terminated. In this embodiment, the schedule is adjusted such that VM(1) and VM(3) are each scheduled six cycles of GPU time such that they take turns using GPU resources in a round-robin scheduling scheme. In other embodiments, GPU resources previously scheduled for an inactive VM are not reallocated to active VMs. Rather, the scheduling remains the same with an allocation of four cycles per active VM and simply terminating the allocation of GPU cycles to inactive VMs.

Although the embodiments discussed herein have primarily been described in the context of GPUs, one of ordinary skill in the art will recognize that the principles described herein are generally applicable to any physical device of a computing system, without departing from the scope of this disclosure.

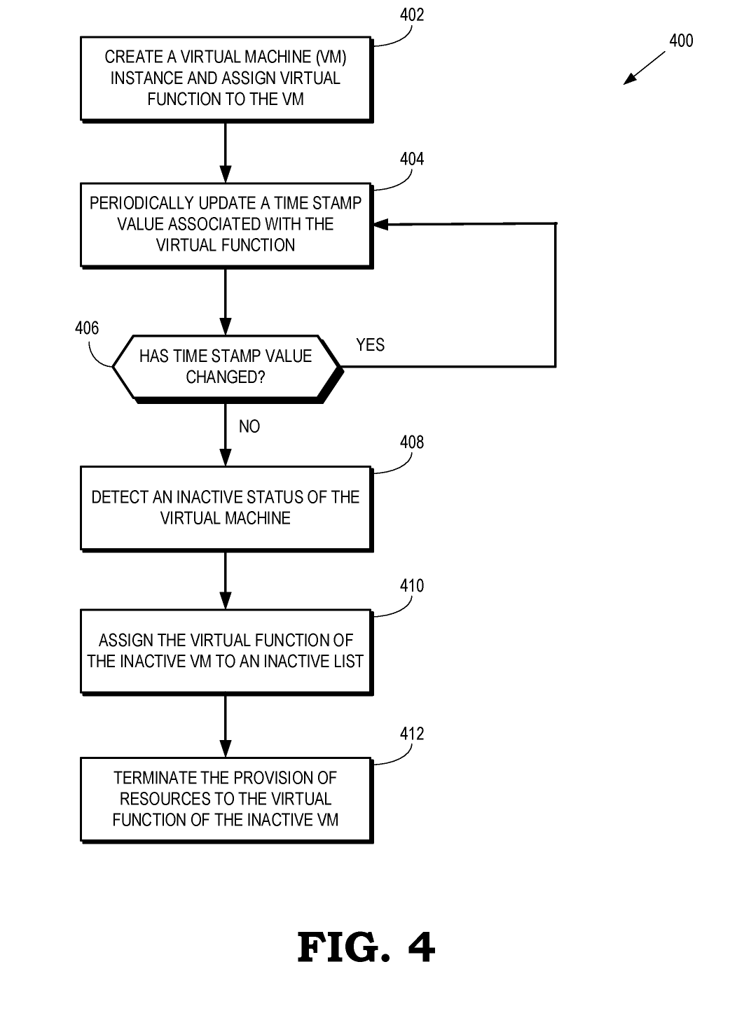

FIG. 4 is a flow diagram illustrating an example method 400 for the detection of inactive virtual machines in accordance with some embodiments.

At block 402, an instance of a guest virtual machine (VM) is created and a virtual function is assigned to the guest VM. In one embodiment, the virtual function is associated with the functionalities of a graphics processing unit (GPU). In another embodiment, the virtual function is associated with the functionalities of a central processing unit (CPU). In other embodiments, the virtual function is associated with the functionalities of a PCIe device, such as a memory device or network adapter.

At block 404, a time stamp value associated with the virtual function is periodically updated. The time stamp value is configured in a shared memory of a host system and a thread instantiated in a device driver of the guest VM is assigned to periodically increment the time stamp value. In one embodiment, the time stamp value is set at a value of zero upon initialization of the guest VM and the time stamp value is periodically incremented by increasing the time stamp value in accordance with the number of cycles of GPU time consumed. In another embodiment, the time stamp value is set at a value of zero upon initialization of the guest VM and the time stamp value is periodically incremented by incrementing the time stamp value with every clock cycle of a CPU or a GPU clock.

At decision block 406, the time stamp value is monitored to determine whether the time stamp value changes over a predetermined time period. If yes, the change in the time stamp value indicates that the guest VM remains active and the method 400 returns to block 404 to continue periodically updating the time stamp value. If no, the method 400 proceeds to block 408 where an inactive status of the guest VM is detected based on the time stamp value not changing over the predetermined time period. In some embodiments, a thread is instantiated in a resource scheduler of the host system that periodically queries the time stamp value to determine whether it has changed. For example, a thread in a GPU scheduler is tasked with monitoring changes to the time stamp value over a predetermined period of time. As long as the guest VM remains active, the time stamp value will continue to change over time.

At block 410, the virtual function of the inactive guest VM is assigned to an inactive list based on the detection of its inactive status from block 408. At block 412, the provision of resources on the host system is terminated to the virtual function of the guest VM based on its inactive status. In one embodiment, the termination of resource provisioning comprises terminating the scheduling of GPU bandwidth to the virtual function of the inactive guest VM. In another embodiment, the termination of resource provisioning comprises terminating the scheduling of CPU processing cycles to the virtual function of the inactive guest VM. In other embodiments, the termination of resource provisioning comprises terminating the scheduling of memory disk access or network usage to the virtual function of the inactive guest VM.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method, comprising:
periodically updating, in a shared memory on a host system, a time stamp value associated with a virtual function of a guest virtual machine (VM);
detecting an inactive status of the guest VM based at least in part on the time stamp value remaining fixed over a specified time period; and
terminating, in response to detecting the inactive status of the guest VM, a provision of a first resource on the host system to the virtual function.

2. The method of claim 1, further comprising:
assigning, in response to detecting the inactive status of the guest VM, the virtual function to an inactive list; and
preventing the virtual function in the inactive list from communicating with the guest VM having the inactive status.

3. The method of claim 1, wherein the virtual function is associated with a graphics processing unit (GPU) and the first resource on the host system comprises cycles of GPU time.

4. The method of claim 1, wherein the virtual function is associated with a central processing unit (CPU) and the first resource on the host system comprises cycles of CPU processing time.

5. The method of claim 1, wherein periodically updating the time stamp value comprises assigning a thread instantiated in a guest VM device driver of the VM to periodically increment the time stamp value.

6. The method of claim 5, wherein assigning the thread comprises assigning one of a plurality of idle worker threads in a thread pool to periodically increment the time stamp value.

7. The method of claim 1, wherein detecting an inactive state of the guest VM includes assigning a thread instantiated in a device scheduler to periodically query the time stamp value and determining whether the time stamp value has changed over the specified time period.

8. The method of claim 1, wherein periodically updating the time stamp value begins after initialization of an instance of the guest VM.

9. A system, comprising:
a server to host a plurality of guest virtual machines (VMs), wherein the server comprises a physical device with resources allocated to the plurality of guest VMs, and further wherein a virtual function associated with the physical device is configured for each of the plurality of guest VMs; and
a shared memory, wherein the shared memory stores a time stamp value for each virtual function of the plurality of the guest VMs, wherein an inactive status of one of the plurality of guest VMs is detected based at least in part on the time stamp value for that one of the plurality of guest VMs remaining fixed over a specified time period.

10. The system of claim 9, wherein the physical device comprises a graphics processing unit (GPU) with cycles of GPU time allocated to the plurality of guest VMs.

11. The system of claim 10, wherein cycles of GPU time are terminated to the virtual function for that one of the plurality of guest VMs having the inactive status.

12. The system of claim 9, wherein the virtual function for that one of the plurality of guest VMs is assigned, in response to detecting the inactive status, an inactive list, and further wherein provisioning of resources is terminated for virtual functions in the inactive list.

13. The system of claim 9, wherein the physical device comprises a central processing unit (CPU) with cycles of CPU processing time allocated to the plurality of guest VMs.

14. The system of claim 9, wherein a thread is instantiated in a guest VM device driver of each of the plurality of guest VMs to periodically increment the time stamp value.

15. The system of claim 9, wherein a thread is instantiated in a device scheduler to periodically query the time stamp value for each virtual function and determine whether the time stamp value has changed over the specified time period.

16. The system of claim 9, wherein the time stamp value begins periodically updating after initialization of each instance of the plurality of the guest VMs

17. A non-transitory computer readable medium embodying a set of executable instructions, the set of executable instructions to manipulate a processor to:
periodically update, in a shared memory on a host system, a time stamp value associated with a virtual function of a guest virtual machine (VM);
detect an inactive status of the guest VM based at least in part on the time stamp value remaining fixed over a specified time period; and
terminate the provision of resources on the host system to the virtual function having the inactive status.

18. The non-transitory computer readable medium of claim 17, wherein the processor is to:
assign, in response to detecting the inactive status of the guest VM, the virtual function to an inactive list; and
prevent the virtual function in the inactive list from communicating with the guest VM having the inactive status.

19. The non-transitory computer readable medium of claim 17, wherein the virtual function is associated with a graphics processing unit (GPU), and further wherein the provision of resources is terminated by terminating the scheduling of cycles of GPU time to the virtual function.

20. The non-transitory computer readable medium of claim 17, wherein the time stamp value is periodically updated by assigning a thread instantiated in a guest VM device driver of the guest VM to periodically increment the time stamp value.
